(19) United States
(12) Patent Application Publication
(10) Pub. No.: US 2009/0168087 A1
(43) Pub. Date: Jul. 2, 2009

(54) IMAGE FORMING APPARATUS AND IMAGE FORMING METHOD

(75) Inventors: Yasunori Fujimoto, Inagi-shi (JP); Shinichi Miyazaki, Kawasaki-shi (JP); Hiroki Horikoshi, Komae-shi (JP); Akira Ichimura, Tokyo (JP); Tomokazu Yanai, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/336,978

(22) Filed: Dec. 17, 2008

(30) Foreign Application Priority Data
Dec. 20, 2007 (JP) 2007-329335

(51) Int. Cl. G06F 15/00

(52) U.S. Cl. 358/1.9

(57) ABSTRACT

An image forming apparatus and an image forming method are provided which can produce an image with high robustness that can keep image impairments from becoming noticeable even when there are printing characteristic variations over a range of positions of the print elements, as in the case of an end deflection phenomenon. This is realized by distributing multilevel grayscale values of individual pixels according to distribution coefficients determined for the individual print elements that print the pixels, allocating the distributed grayscale values to the associated planes, and binarizing the allocated grayscale values in each plane. With this process, the grayscale value distribution factors in each scan of multipass printing can be determined according to the positions of individual print elements on the print head.

### BACKGROUND OF THE INVENTION

1. Field of the Invention

The present invention relates to an image forming apparatus and an image forming method that reduces variations in printing characteristics among a plurality of print elements in a print head, fluctuations of scans of the print head, and density unevenness resulting from unstable conveying of a print medium.

2. Description of the Related Art

Among the printing systems using a print head with a plurality of print elements is an ink jet printing system that ejects ink from individual print elements to form dots on a print medium. An ink jet printing apparatus of a serial type in particular forms an image by intermittently alternates a printing scan, that scans the print head at a speed corresponding to its ink ejection frequency, and a conveying operation, that conveys the print medium in a direction crossing the direction of printing scan. Such a serial type of ink jet printing apparatus can be manufactured in a relatively small size and at a low cost and therefore has found a wide range of applications for personal use.

In a print head having a plurality of print elements arrayed, variations in ink ejection volume and ejection direction occur among print elements. These variations may cause density unevenness or stripes.

To deal with this problem, a conventional practice has been to use a characteristic printing method called a multipass printing.

FIG. 15 is a simplified schematic diagram showing an operation of a multipass printing of 2-pass. In the 2-pass printing, image data that can be printed by a print head 105 in one printing scan is distributed to two planes that are complementarily printed in two printing scans between which a paper conveying operation is interposed. The paper conveying operation executed between individual printing scans moves the print medium one-half the print width d of the print head 105.

The above arrangement prevents those dots printed by a single print element from continuing in the main scan direction. So, if individual print elements have ejection characteristic variations, influences of these variations can be scattered in a wide range, helping to form a uniform and smooth printed image. While the figure takes up a 2-pass printing as an example, the effect of the multipass printing increases as the number of passes, i.e., the number of print elements used to print one scan raster, increases. However, since the printing speed decreases as the number of passes increases, the serial type printing apparatus often provides a plurality of print modes with different passes.

When such a multipass printing is performed, it is necessary to distribute the image data to individual printing scans. Such data distribution has often been done using a mask pattern having arrayed therein print-permitted pixels (1) where dots are allowed to be printed and print-not-permitted pixels (0) where dots are not allowed to be printed.

FIG. 16 is a schematic diagram showing one example mask pattern that can be used in a 2-pass printing. Areas shown in black represent print-allowed pixels (1) and those shown in white represent print-not-allowed pixels (0) Denoted 1801 is a mask pattern used in a first-pass printing scan and 1802 a mask pattern used in a second-pass printing scan. The pattern 1801 and the pattern 1802 are complementary to each other.

By performing a logical AND operation between the mask patterns and binary image data, the binary image data is distributed into two pieces of image data that need to be printed in two printing scans. For example, as shown in FIG. 2, image data representing dots to be printed in the same image area is distributed by the mask patterns (1801, 1802) of FIG. 16 to generate 1st-pass image data and 2nd-pass image data. With this data distribution method (divide-by-mask data allocation method) using the mask patterns that are in a complementary relation, the distributed pieces of binary image data corresponding to the two different scans are also in a complementary relation, so that the possibility of the dots printed in different scans overlapping each other is greatly reduced. Therefore, a high density level resulting from high dot coverage can be realized. In addition, good granularity is also assured.

While such a multipass printing is in wide use today, increasingly onerous demands are being made for higher quality of image. Under this circumstance, density unevenness and fluctuations resulting from registration deviations among different printing scans have come to be seen as a new problem. Registration deviations between different printing scans are caused by variations in distance between a print medium and an ejection face of the print head and variations in conveying distance of the print medium.

Referring to FIG. 2, let us consider a case where a plane of dots (circle) printed in a preceding printing scan and a plane of dots (double circle) printed in a subsequent printing scan are shifted by one pixel in the main scan or subscan direction. At this time, the dots (circle) printed in the preceding printing scan and the dots (double circle) in the subsequent printing scan are completely overlapped, exposing blank areas, lowering the density level of the printed image. If the two planes of dots are not shifted by as large as one pixel but the distance between adjoining dots or their overlapping amounts changes, the dot coverage over the blank area also changes, resulting in variations in image density level. Such variations are perceived as density unevenness or fluctuations.

Today, with increasingly higher quality being called for, there is a growing demand for an image data processing method which, during a multipass printing, can deal with possible registration deviations between planes caused by variations in many printing conditions. In the following descriptions, a tolerance or resistance to density unevenness or fluctuations caused by inter-plane registration deviations that result from whatever variations in printing conditions is called a “robustness”.

Japanese Patent Laid-Open No. 2000-103088 discloses an image data processing method for enhancing the robustness. This document focuses on the fact that image density unevenness resulting from variations in many printing conditions are caused by a perfect complementary relation between distributed pieces of binary image data allocated to different printing scans. The document also recognizes that a multipass printing with an excellent “robustness” can be realized by generating pieces of image data corresponding to different printing scans in such a way that reduces the complementary relationship between the pieces of image data. To that end, Japanese Patent Laid-Open No. 2000-103088 distributes the image data in the form of the multivalued data before being binarized and then independently binarizes the distributed pieces of multivalued data. This process prevents large density unevenness from occurring even if the distributed image data allocated to different planes for different printing scans are printed deviated from each other.

FIG. 3 shows a data distributing method disclosed by Japanese Patent Laid-Open No. 2000-103088. First, multivalued image data (15001) to be printed in the same image area is distributed into multivalued data (15002) to be printed in a first pass and multivalued data (15003) to be printed in a second pass. Next, the distributed multivalued data are independently binarized to generate binary data (15004) to be printed in the first pass and binary data (15005) to be printed in the second pass. Lastly, according to these binary data, the print head ejects ink. As can be seen from (15004) and (15005) of FIG. 3, the 1st-pass binary data and the 2nd-pass binary data generated as described above are not in a perfect complementary relation. Thus, locations where dots overlap (pixels where both of the two planes have “1”) and locations where dots do not overlap (pixels where only one of the two planes has “1”) exist in one and the same image area.

FIG. 4 shows dots formed on a print medium according to the above method of Japanese Patent Laid-Open No. 2000-103088. In the figure, black circles 21 represent dots printed in the first pass, white circles 22 represent dots printed in the second pass, and hatched circles 23 represent dots overlappingly printed in both the first and second pass. In this example, since the complementary relation in image data between the first pass and the second pass is not perfect, areas where two dots overlap and areas where dots are not printed (blank areas) exist parallelly, unlike the case of FIG. 2 where the distributed image data are in a perfect complementary relation.

Let us consider a case similar to FIG. 2 in which dots printed in a first pass and dots printed in a second pass are shifted by one pixel either in the main scan or subscan direction. In this case, while the 1st-pass dots and the 2nd-pass dots that are supposed to be printed in separate positions overlap each other, those dots 23 supposed to overlap unless there is no registration deviation fail to overlap. Thus, with an area of some expanse considered, the dot coverage in blank areas does not change much, resulting in little change in image density. That is, the method of Japanese Patent Laid-Open No. 2000-103088 can suppress variations in the image density even if changes occur in the distance between the print medium and the ejection face of the print head and in the amount of conveying of the print medium.

Further, Japanese Patent Laid-Open No. 2006-231736 discloses a technique that, while distributing image data in the form of multivalued image data to a plurality of printing scans or a plurality of print element columns, changes a distribution factor according to the position of the pixel of interest. This document describes an advantage of being able to suppress undesired banding or color unevenness during a multipass printing by changing a distribution factor linearly, cyclically, sinusoidally or based on combined high and low frequency waves according to the position of the image data in the main or subscan direction.

However, the study of the inventors of this invention has found that, even with the methods of Japanese Patent Laid-Open No. 2000-103088 and 2006-231736, the ink ejected from the printing elements near the ends of the print head may deflect from the intended direction (this phenomenon is hereinafter referred to as an “end deflection”), forming visible boundary lines between print head scans. Image impairments caused by the end deflections will be briefly explained as follows.

In a print head having printing elements arrayed at high density and capable of ejecting small ink droplets at high frequency, an air flow is produced between the print head and the print medium, influencing the direction of individual ink droplets being ejected. More specifically, a phenomenon is observed in which when the print head ejects ink from a plurality of its print elements arrayed in line, ink ejected from those print elements located near the ends of the print head deflects toward the center of the print head.

FIG. 18 schematically shows image impairments caused by the end deflections. Here is shown a printed state of a print medium when a uniform image is printed in one printing scan. Since ink droplets ejected from those nozzles situated at the ends of the print head are drawn toward the center of the print head as they land on the print medium, the areas of the print medium corresponding to the central portion of the print head is higher in density than the areas corresponding to the end portions. If the image areas formed in this manner continue in the subscan direction, band-like density unevenness emerges over the entire image.

Such a density unevenness from the end deflections is not caused by problematic ejection characteristics of individual print elements nor by inter-plane registration deviations. Since the density area of a certain width printed by the print elements near the ends of the print head is constantly lower than other areas, this problem cannot be solved easily even with the above multipass printing. In a print mode with a small number of passes of multipass printing, the ink ejection frequency in individual printing scans becomes high, making the end deflection phenomenon more visible. Unless an end deflection phenomenon is involved if there are large variations in printing characteristics according to the positions of print elements, the print mode with a small number of multipass printing cannot fully eliminate the image impairments caused by the problematic print elements.

### SUMMARY OF THE INVENTION

The present invention has been accomplished to solve the above problems. It is therefore an object of this invention to produce an image with high robustness while keeping image impairments caused by printing characteristic variations according to the positions of print elements, such as caused by the end deflections, hardly noticeable.

The first aspect of the present invention is an image forming apparatus for forming an image on a print medium by using a print head having a plurality of print elements that print dots, the image forming apparatus comprising: distribution unit configured to distribute multilevel grayscale data of pixels according to distribution coefficients determined for the print elements to be used to print dots to the pixels; grayscale reduction unit configured to reduce values of the grayscale data distributed by said distribution unit; and printing controller configured to cause the print head to print the dots on the print medium according to the data whose values are reduced by said grayscale reduction unit.

The second aspect of the present invention is an image forming method for forming an image on a print medium by using a print head having print elements that print dots on the print medium, the image forming method comprising: a distribution step of distributing multilevel grayscale data of pixels according to distribution coefficients determined for the print elements to be used to print dots to the pixels; a grayscale reduction step of reducing values of the grayscale data distributed by said division step; and a step of printing dots on the print medium according to the data whose values are reduced by said grayscale reduction step.

The third aspect of the present invention is a data processing apparatus for processing data used to form an image on a print medium by using a print head having print elements that print dots, the processing comprising: a distribution step of distributing multilevel grayscale data of pixels according to distribution coefficients determined for the print elements to be used to print dots to the pixels; and a step of reducing values of the grayscale data distributed by said division step.

Further features of the present invention will become apparent from the following description of exemplary embodiments (with reference to the attached drawings).

### BRIEF DESCRIPTION OF THE DRAWINGS

FIG. 1 is a schematic diagram showing an inner construction of a serial type ink jet printing apparatus used in an embodiment of this invention;

FIG. 2 shows an example of arrangement of print-permitted pixels in binary image data and a result of division of the print-permitted pixels into two printing scans according to a method disclosed in patent document 2;

FIG. 3 is a schematic diagram showing a data allocation method disclosed in Japanese Patent Laid-Open No. 2000-103088;

FIG. 4 shows an arrangement of dots on a print medium printed by the method of Japanese Patent Laid-Open No. 2000-103088;

FIG. 5 is a block diagram showing a sequence of steps of image processing executed by a printing apparatus applicable to this invention;

FIG. 6 is a schematic diagram showing the relationship FIGS. 6A, 6B and 6C;

FIG. 6A is a schematic diagram showing a method of allocating image data to a plurality of planes, executed by an image allocation unit 103 of embodiment 1;

FIG. 6B is a schematic diagram showing a method of allocating image data to a plurality of planes, executed by an image allocation unit 103 of embodiment 1;

FIG. 6C is a schematic diagram showing a method of allocating image data to a plurality of planes, executed by an image allocation unit 103 of embodiment 1;

FIG. 7 is a schematic diagram showing the relationship of FIGS. 7A, 7B and 7C;

FIG. 7A is a schematic diagram showing a method of allocating image data to a plurality of planes, executed by an image allocation unit 103 of embodiment 2;

FIG. 7B is a schematic diagram showing a method of allocating image data to a plurality of planes, executed by an image allocation unit 103 of embodiment 2;

FIG. 7C is a schematic diagram showing a method of allocating image data to a plurality of planes, executed by an image allocation unit 103 of embodiment 2;

FIG. 8 is a schematic diagram showing the relationship of FIGS. 8A, 8B and 8C;

FIG. 8A is a schematic diagram showing another example of method of allocating image data to a plurality of planes, executed by the image allocation unit 103 of embodiment 2;

FIG. 8B is a schematic diagram showing another example of method of allocating image data to a plurality of planes, executed by the image allocation unit 103 of embodiment 2;

FIG. 8C is a schematic diagram showing another example of method of allocating image data to a plurality of planes, executed by the image allocation unit 103 of embodiment 2;

FIG. 9 is a block diagram showing a sequence of steps of image processing executed by a printing apparatus of embodiment 3;

FIG. 10 is a block diagram showing a functional configuration of an image allocation/binarization unit 107;

FIG. 11 is a schematic diagram showing diffusion coefficients for adjoining pixels used in diffusion processing executed by an error diffusion unit 157;

FIG. 12 is a block diagram showing a sequence of steps of image processing executed by the printing apparatus of embodiment 3;

FIG. 13A shows coefficients that the limitation information calculation unit 206 uses in executing a filter calculation on binary data for a first plane output from the binarization unit 205; and FIG. 13B shows a result of calculation;

FIG. 14 shows an output result from the binarization unit 205 and an image of the output result after being subjected to the filter processing;

FIG. 15 is a schematic diagram roughly showing an operation of a 2-pass printing;

FIG. 16 is a schematic diagram showing an example of mask patterns that can be used in the same image area during the 2-pass printing;

FIG. 17A and FIG. 17B show two different error allocation matrices;

FIG. 18 is a schematic diagram showing an image impairment caused by end nozzle droplet deflections; and

FIG. 19 shows another configuration of an ink jet printing apparatus applicable to this invention.

### DESCRIPTION OF THE EMBODIMENTS

Now, embodiments of this invention will be described in detail by referring to the accompanying drawings.

First, terminologies employed in this specification will be defined. “Relative scan (relative movement)” refers to an operation to move (scan) a print head relative to a print medium.

The “multipass printing” refers to a printing method which completes an image to be formed in a same image area of a print medium by performing a plurality of relative scans of a print head over the same image area. The “number of passes (M)” refers to the number of relative movements of the print head over the same image area. M is an integer equal to 2 or more. If M=2, the multipass printing is a 2-pass printing; and if M=4, it is a 4-pass printing. In the case of an M-pass printing, image data is generated for M planes corresponding to the M passes according to multivalued image data for the same image area. The image data for the M planes are printed in M passes.

The “planes” refer to sets of image data corresponding to the relative movements of the print head over the print medium. So, different planes correspond to different relative print head movements. Further, the “pixels” each refer to a minimum unit area whose grayscale level can be represented by multivalued image data.

### Embodiment 1

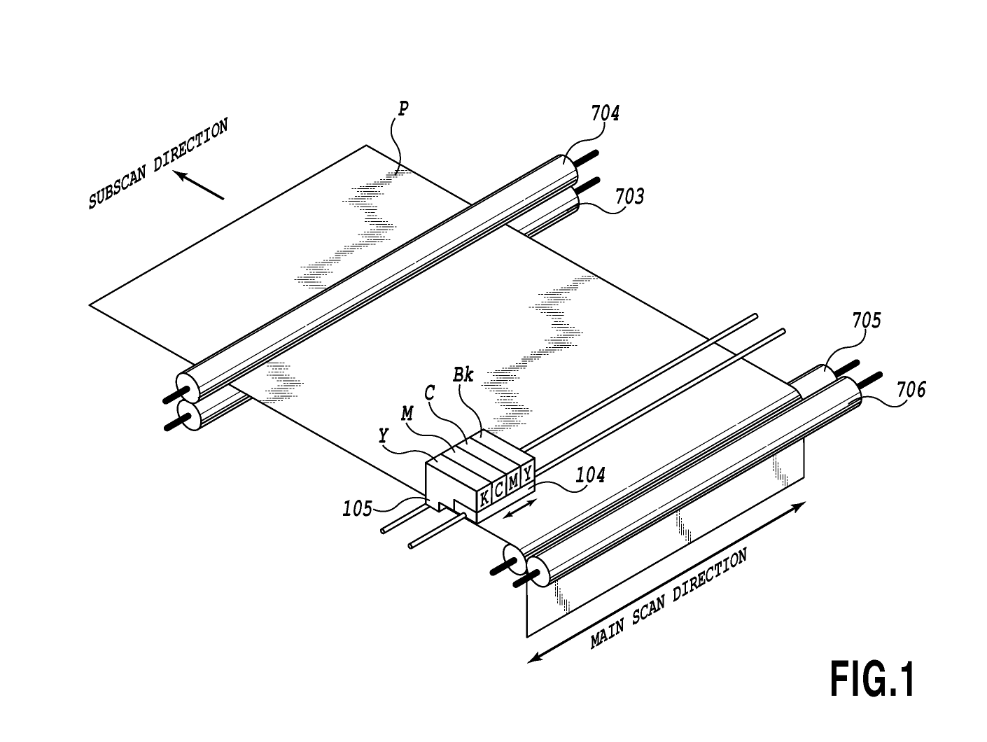

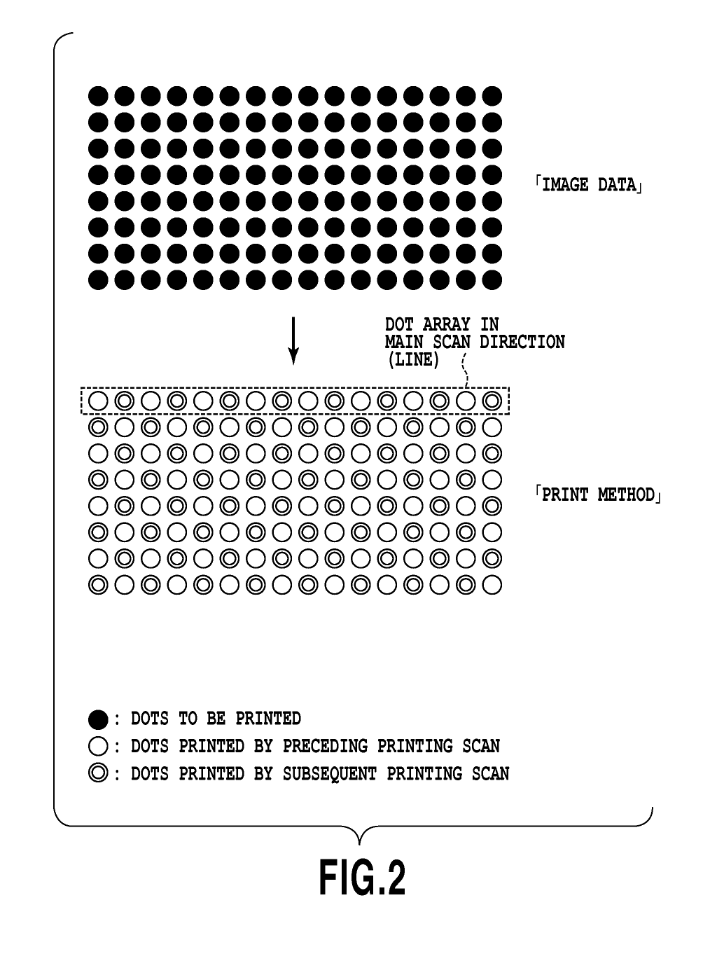

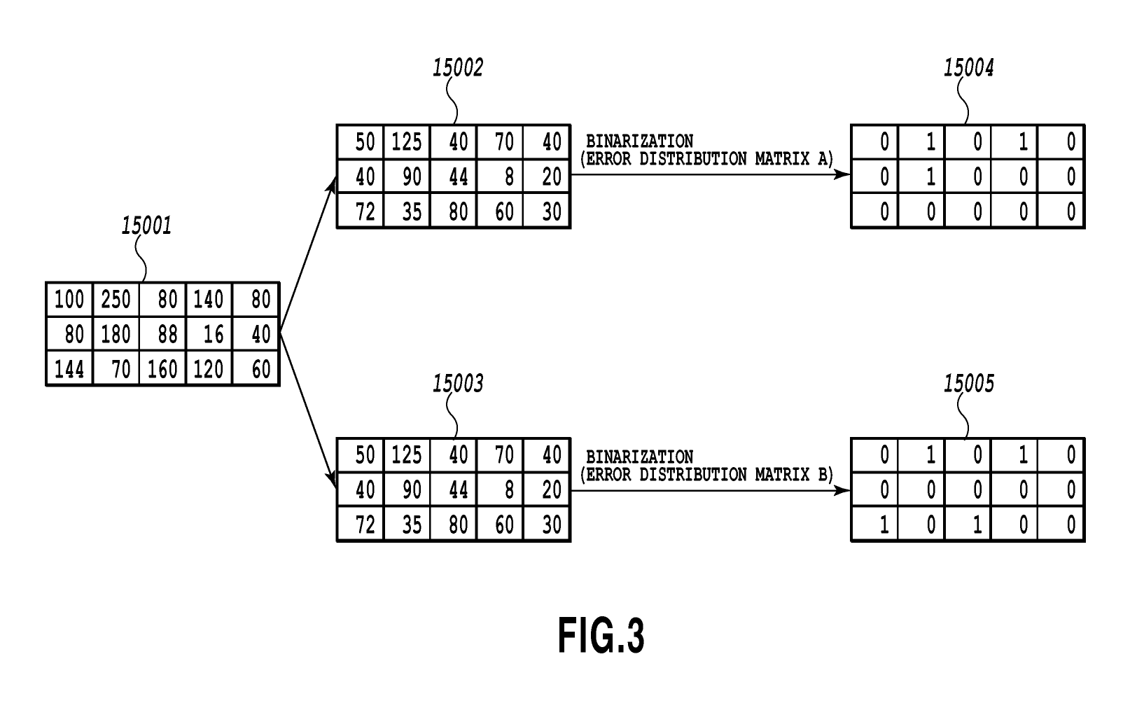

FIG. 1 is a schematic diagram showing an internal construction of a serial type ink jet printing apparatus used in this embodiment. A print head 105 is mounted on a carriage 104 traveling in the main scan direction at a constant speed and ejects ink in droplets at a frequency corresponding to the constant speed. When one printing scan is finished, a conveying roller 704 and an auxiliary roller 703 rotate and a print medium P held between these paired rollers and between a paper supply roller 705 and an auxiliary roller 706 is conveyed a distance in the subscan direction corresponding to a print width of the print head 105. With the printing scan and the paper conveying operation alternated repetitively, an image is formed progressively on the print medium P.

The print head 105 comprises black (K), cyan (C), magenta (M) and yellow (Y) print heads arranged parallelly side by side in the main scan direction, as shown. Each of these color print heads has a plurality of print elements arrayed in line in the subscan direction at a density corresponding to a print resolution.

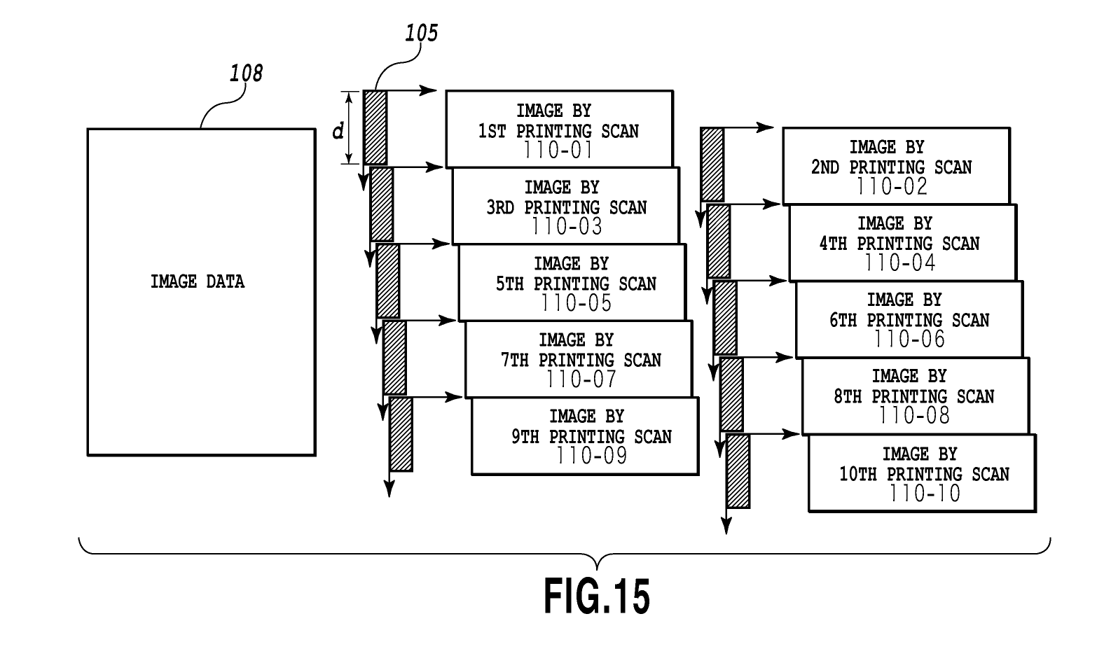

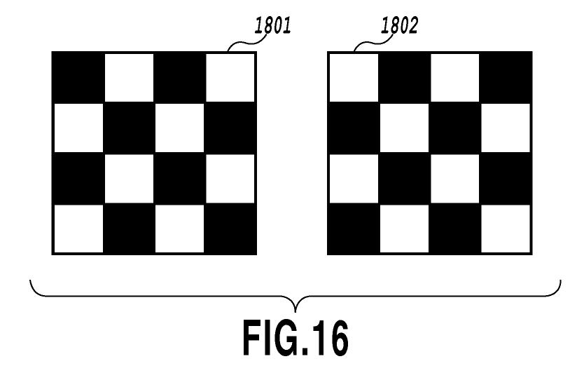

In this embodiment a 2-pass printing is taken for example. Referring again to FIG. 15, the print head 105 in its first relative scan (also referred to as a printing scan) prints that part of image data 108 for an area corresponding to a width d of the print head. At this time, image data 110-01 that the print head 105 actually prints is approximately one-half (½) the multilevel grayscale value of the original image data for the pixels concerned. Next, the print medium is conveyed a distance of d/2 in a direction crossing the direction of the main scan before the second printing scan is performed. Image data 110-02 printed in the second printing scan is also about ½ the grayscale value of the original image data for the pixels concerned. When we look at the same image area where the first and the second printing scan overlap, the area is printed twice with one-half the original grayscale value so that the grayscale value of the original image data is preserved. The printing scan continues further into third and fourth scan and so on with the paper conveying operation performed between the paired printing scans until the entire image area for the original image data is printed by twice printing scans.

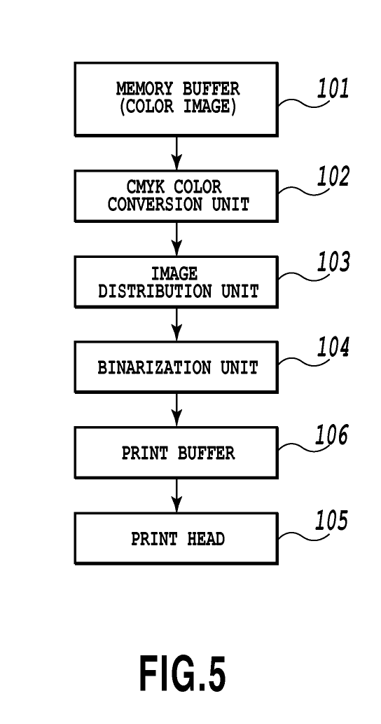

FIG. 5 is a block diagram showing a sequence of steps of the image processing executed by the printing apparatus of this embodiment. When for example the printing apparatus receives a print command and image data from an externally connected host device, it stores the image data in a memory buffer 101. The print command includes a print mode specifying the number of passes M (in this example, M=2) and a command specifying the kind of print medium. The image data received is 8-bit 256-level brightness data (R, G, B) for each pixel. The brightness data stored in the memory buffer 101 is transferred by one pixel to a CMYK conversion unit 102 where it is converted into multivalued (8-bit 256-level) grayscale value representing an ink color used in the printing apparatus. The converted image data corresponds to the entire image data 108 of FIG. 15.

An image distribution unit 103 distributes the whole image data 108 to a plurality of planes 110-01 to 110-X.

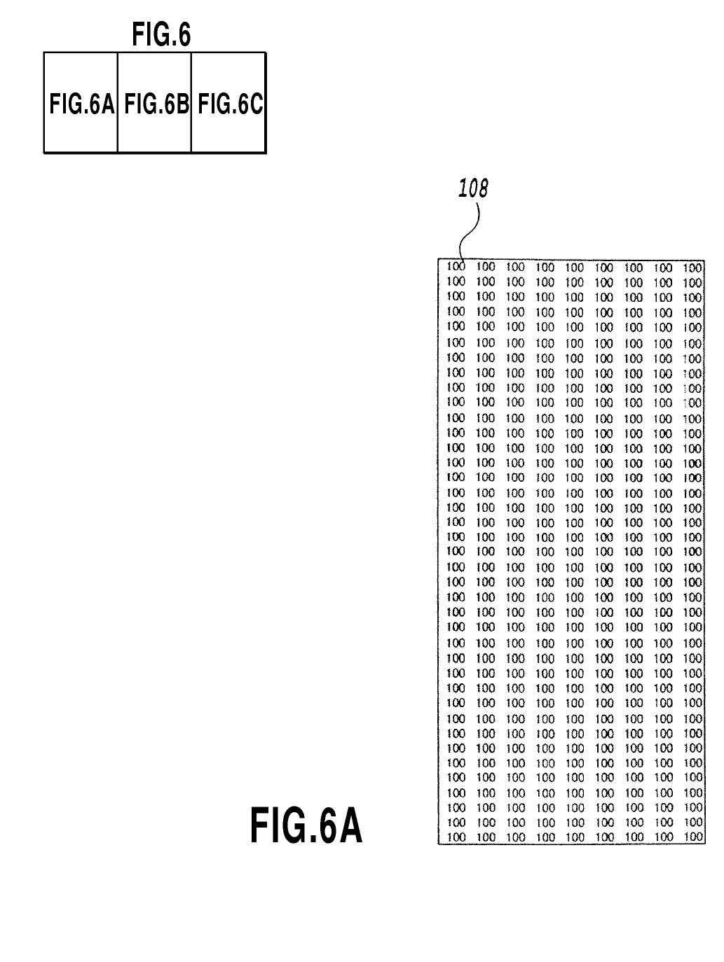

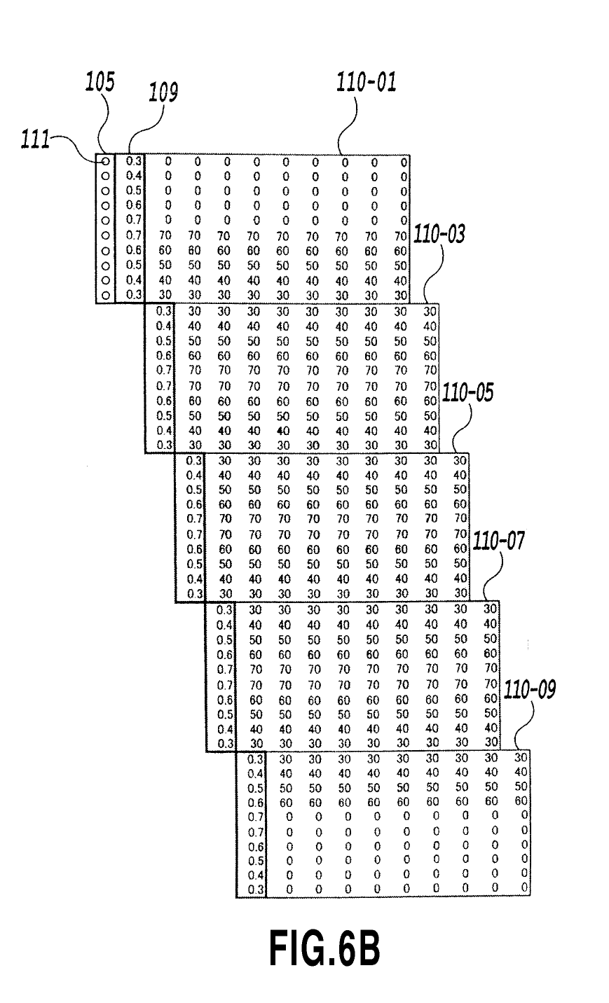

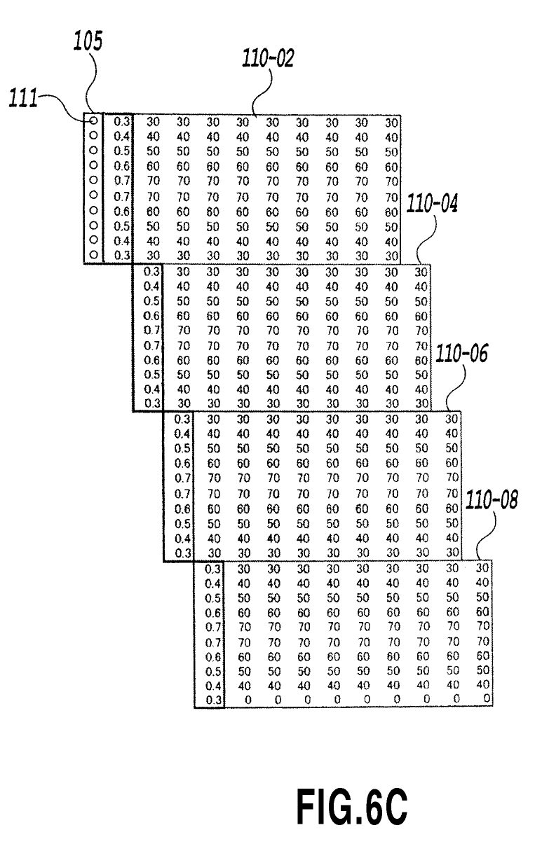

FIGS. 6A to 6C are schematic diagrams showing a method of distributing image data to a plurality of planes, executed by the image distribution unit 103 of this embodiment. Here, for the sake of simplicity, the print head 105 is assumed to have only 10 print elements 111 arrayed in line in the subscan direction. It is also assumed that the image data 108 has a grayscale value of 100 in each of the pixels arrayed in 40 parallel lines arranged in the subscan direction.

In this embodiment, each of the 10 print elements 111 are assigned a distribution coefficient 109 defining a grayscale value distribution factor. Each print element 111 prints image data based on the assigned distribution coefficient in every printing scan. The image distribution unit 103 matches the distribution coefficients 109 to the positions of the image data to be printed in the first printing scan (uppermost part of the image data) to generate a first plane 110-01 to be printed in the first printing scan. More specifically, the grayscale value of each pixel is multiplied by its associated distribution coefficient 109 to determine a new grayscale value for each pixel.

For example, a distribution coefficient 109 corresponding to the print element located at the center of the print head is 0.7. So, a central part of the first plane 110-01 is assigned a grayscale value of 100×0.7=70. For a print element located at the end of the print head, their distribution coefficient 109 is 0.3, so that an end portion of the first plane 110-01 is assigned a grayscale value of 100×0.3=30. In other areas, too, grayscale values 40, 50 and 60 obtained from distribution coefficients 0.4, 0.5 and 0.6 are assigned to the corresponding positions.

As to a plane 110-02 for the second printing scan, the distribution coefficients 109 are matched to a portion of the image data 108 that is shifted five pixels from the first plane and grayscale values of individual pixels are calculated in the same way as in the first plane 110-01. Also for succeeding third to ninth plane 110-03 to 110-09, grayscale values are determined in the similar manner. The grayscale values thus obtained are transferred to the binarization unit 104 for each plane (see FIG. 5).

This embodiment performs a 2-pass printing in which individual pixel lines running along the main scan direction are printed by two different print elements in two printing scans. For example, the first pixel line of the image data 108 is printed by a print element situated at the center of the print head in the first printing scan and by a print element situated at the end of the print head in the second printing scan. As can be seen from FIG. 6, distribution coefficients for these two print elements are 0.7 and 0.3, the sum of them being 1.0. In this embodiment the individual distribution coefficients are determined so that the sum of the distribution coefficients for the print elements used in two printing scans is always 1.0 for any of the pixel lines, thus maintaining a constant grayscale level (density) of the image data 108 over an image printed by the multipass printing.

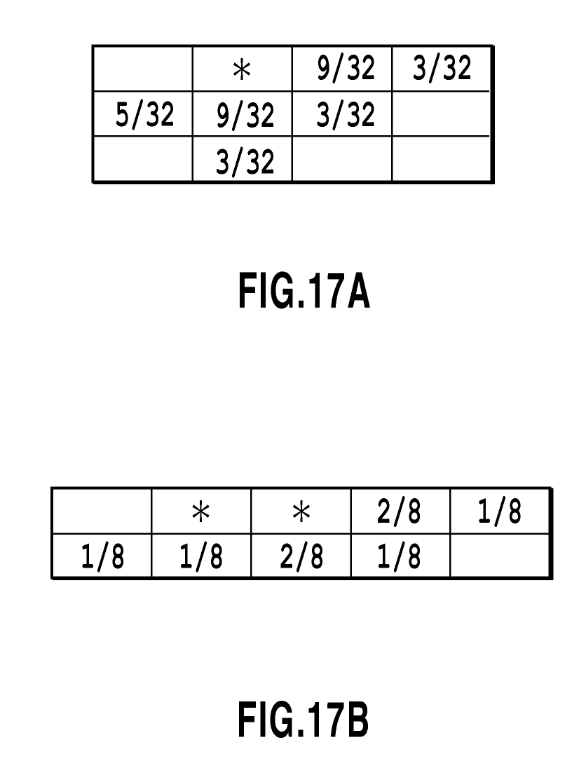

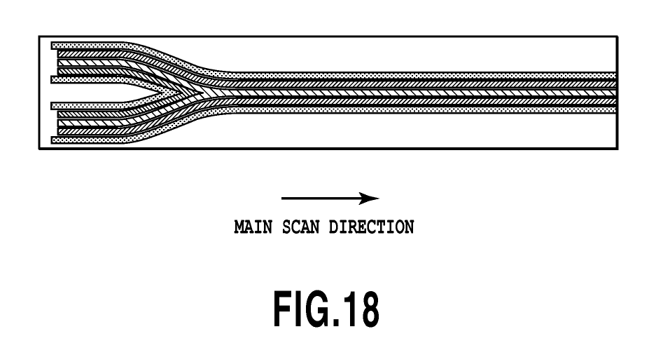

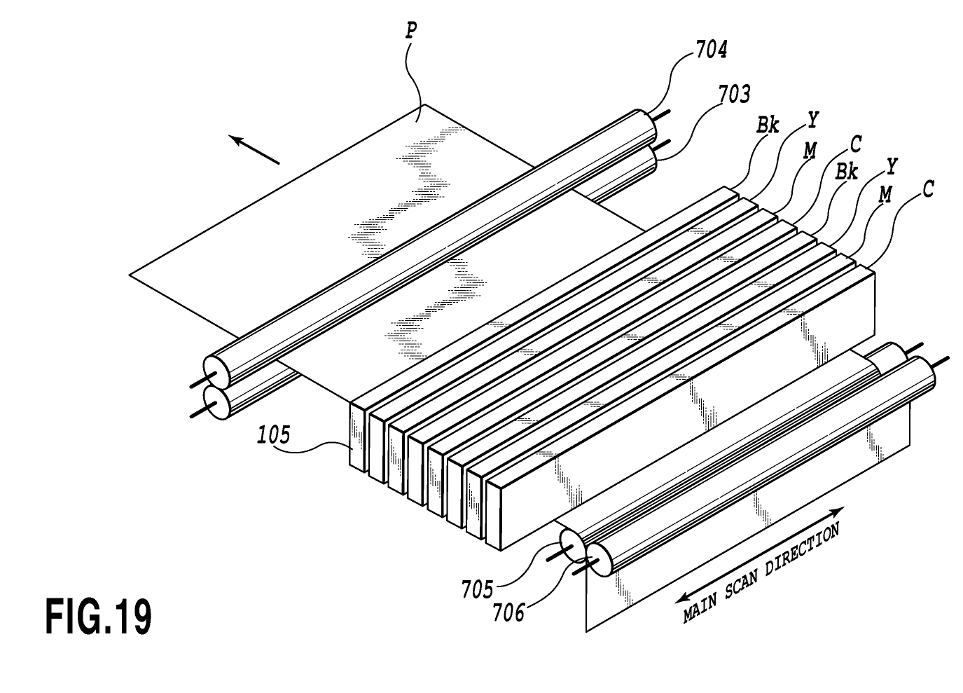

The image data sent to the binarization unit 104 is binarized for each plane. The method of this binarization may be based on a known error diffusion method or dither matrix method. It is, however, preferred to use different binarization methods on these two planes so that an image has areas of pixels where, when the two processed planes are overlapped, dots overlap and areas where they do not. If, for example, an error diffusion method is used as the binarization method, it is desired that some provisions be made, such as using different thresholds or different error distribution matrices for the two planes, to ensure that, if image data of the same grayscale values are entered, the results of binarization of the two planes differ. For example, the dot arrangements can be made to differ between the two planes by using an error distribution matrix of FIG. 17A for one plane and an error distribution matrix of FIG. 17B for the other. It is also possible to have the dot arrangements differ between the two planes by using different dither matrices for these two planes. Further, the dot arrangements can also be differentiated between the two planes by using a dither matrix method for one plane and an error diffusion method for the other.

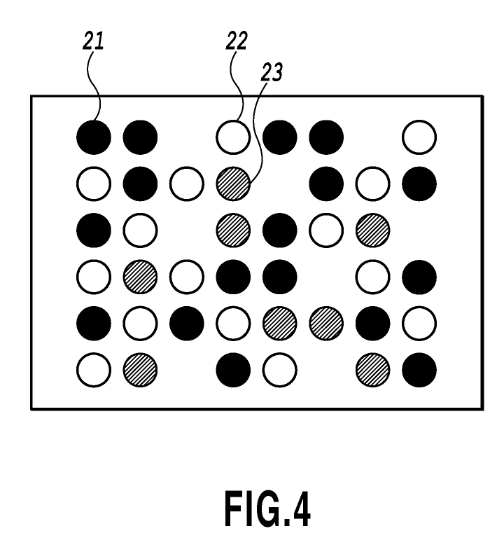

The above binarization process, when two planes are overlapped, allows pixels where dots overlap (pixels with “1” in both planes) and pixels where dots do not overlap (pixels with “1” in only one plane) to exist in an image being formed. Therefore, as explained with reference to FIG. 4, density variations of an image can be minimized even if registration shifts should occur as a result of variations in the distance between the print medium and the ejection face of the print head or variations in the conveying distance of the print medium. Referring again to FIG. 5, the binary data generated by the binarization unit 104 executing the above binarization process is stored in the print buffer 106 for each plane.

Then, according to the binary data stored in the planes, printing scans are successively executed by the print head 105. Performing the printing scan a plurality of times over the same image area causes the image data stored in the memory buffer 101 to be printed progressively on a print medium.

Referring again to FIG. 6, this embodiment has a distribution coefficient set high for the print element situated at the center of the print head and set to progressively decrease toward the end of the print head. This is intended also in the binarized image data to make the print duty of the print element situated at the center of the print head higher than the print duty for the print element situated at the end. With this arrangement, whatever image data may be printed, the ejection operation of the print elements situated at the end of the print head is suppressed more than those situated at the center, rendering the end deflection phenomenon explained in the “Background of the Invention” less noticeable. That is, by lowering the ejection frequency of those print elements at the ends of the print head whose ejected ink droplets are likely to deflect toward the center of the print head and by compensating for the reduced ejection frequency by the print elements at the central part of the print head whose ink droplets do not easily deflect, the end deflection problem can be made less noticeable in a printed image.

This embodiment is characterized in that the distribution coefficients are determined according to the positions of the print elements in the print head. In addition to the end deflection, this embodiment is also effectively applicable to other image impairment problems as long as the position of a print element that causes some impairments in a printed image can be determined.

Although the 2-pass printing has been described for the sake of simplicity, this embodiment can also be applied to more than 2 passes. When, for example, M-pass printing is done, the same effect as this embodiment can be produced by determining individual distribution coefficients for the print elements involved in the printing of the same pixel line such that the sum of these distribution coefficients is 1.0 and by executing the printing scan M times over the same image area.

In the embodiment described above, a binarization operation is adopted as quantization processing to transform multivalued data into binary data by the binarization unit 104. However, the quantization processing applicable to this embodiment is not limited to the binarization operation but may use an N-value transformation operation in general (N is an integer equal to or higher than 2), such as 3- or 4-value transformation as long as a sum of the distribution coefficients for a plurality of print elements that print the same pixel line is 1.0. When a 3-value transformation operation is employed, for example, the binarization unit 104 needs only to be replaced by a 3-value transformation unit, so that the ink ejection is performed based on the 3-value data.

### Embodiment 2

This embodiment also uses the printing apparatus of embodiment 1 shown in FIG. 1. In embodiment 1, with reference to FIG. 6, explanations have been given to the distribution coefficient and the printing method with a print head used having 10 print elements. Normally, the print head has many more print elements and if distribution coefficients are prepared for each of these print elements, a large memory area is needed. This embodiment is characterized by the individual print elements being provided with different distribution coefficients while keeping the number of distribution coefficients to be stored fewer than that of the print elements.

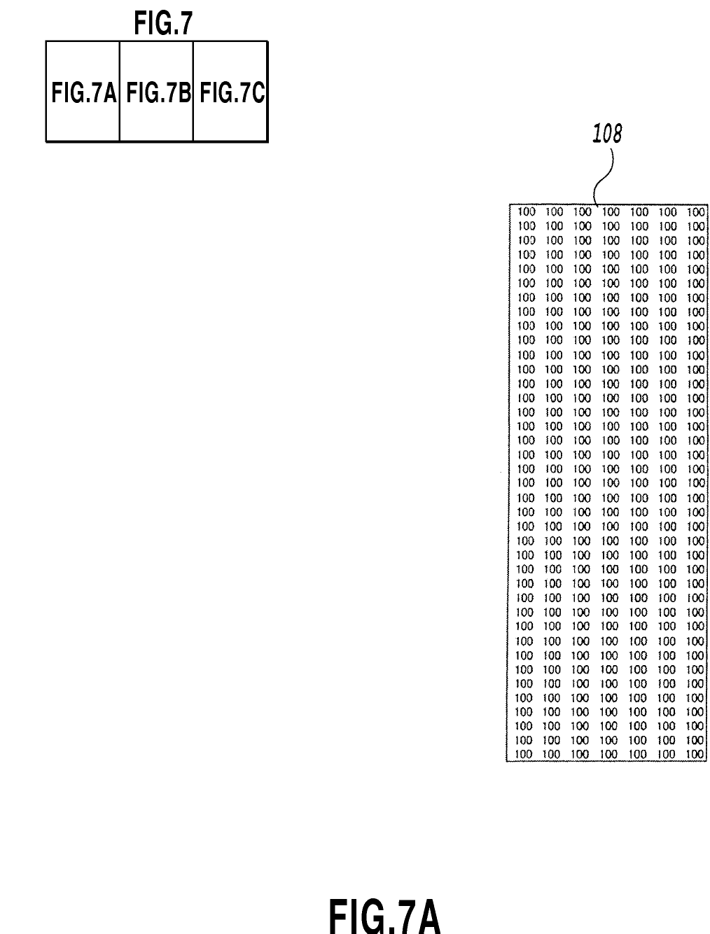

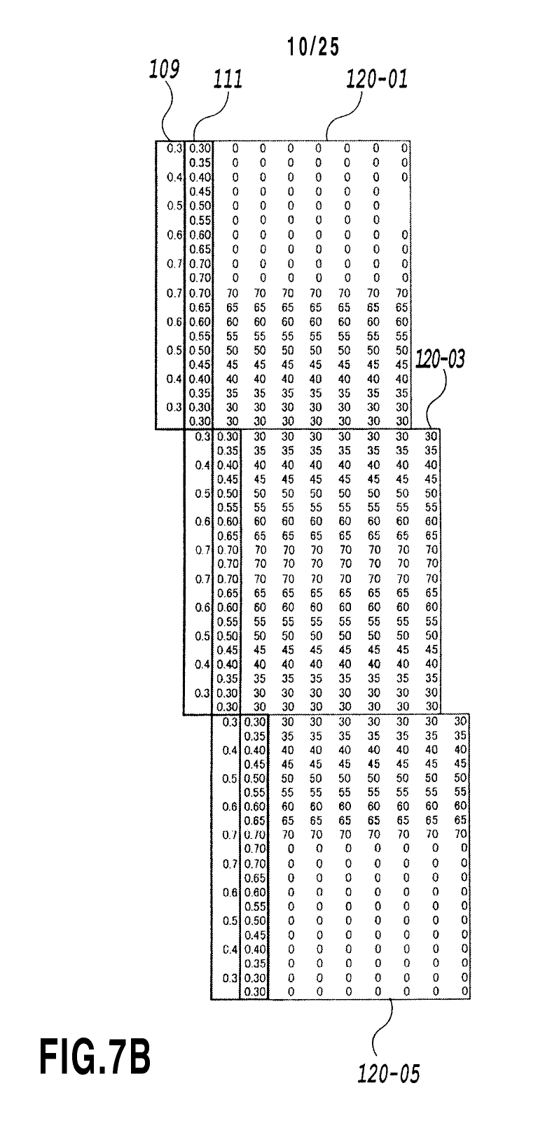

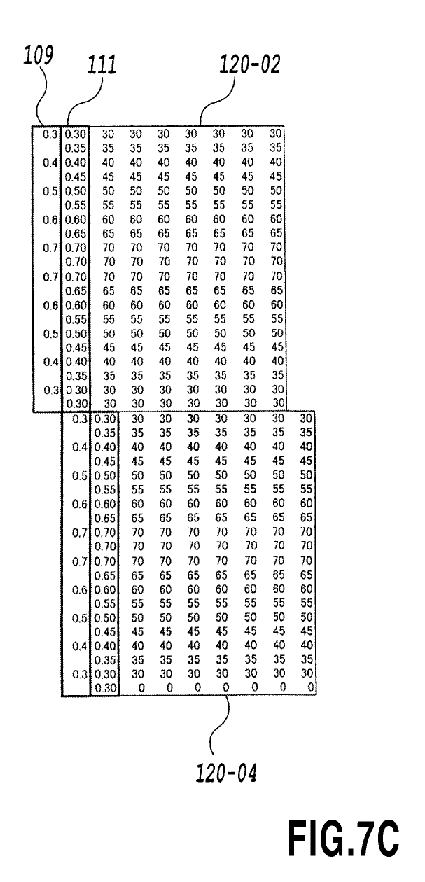

FIG. 7 is a schematic diagram showing the method of distributing image data when a 2-pass printing is performed using a print head with 20 print elements. Since 20 print elements are used, when the same size of image data 108 as in the embodiment 1 of FIG. 6 is printed, the entire image can be completely printed by distributing the image data into five planes of image data (120-01 to 120-5) for five printing scans.

As in embodiment 1, this embodiment also sets a distribution coefficient for the central print elements of the print head at 0.7 and a distribution coefficient for the end print elements at 0.3. It is noted, however, that the number of distribution coefficients to be stored is 10, the same as in embodiment 1, and these are matched to every other print element. The remaining print elements are each allocated an average of distribution coefficients of two adjoining print elements. In FIG. 7, denoted 109 are distribution coefficients stored for the 10 print elements, and reference number 111 represents distribution coefficients interpolated from the distribution coefficients 109. In this embodiment, the interpolation between discrete coefficients is executed by the image distribution unit 103 prior to the distribution of image data to a plurality of planes.

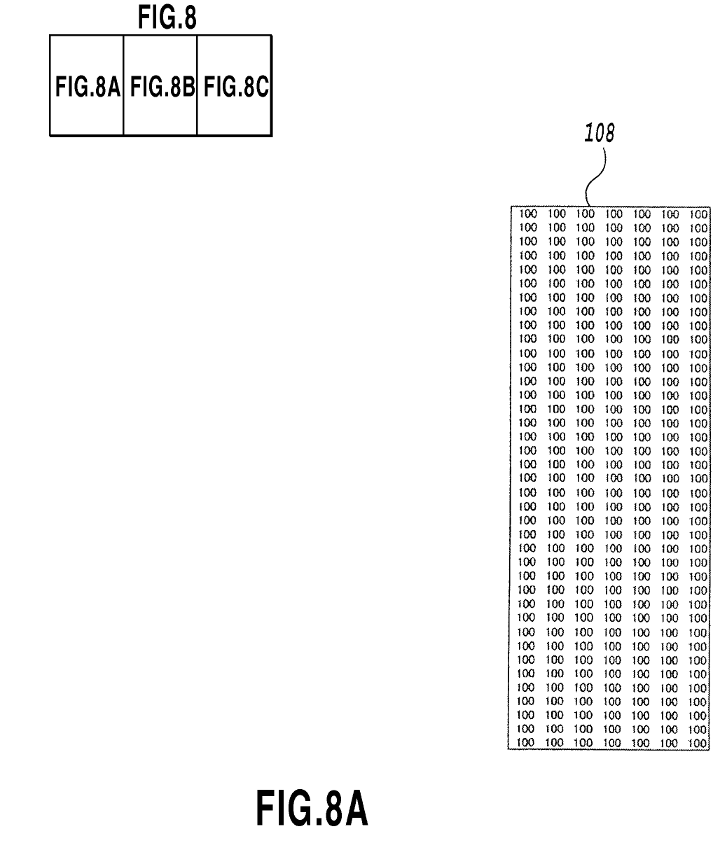

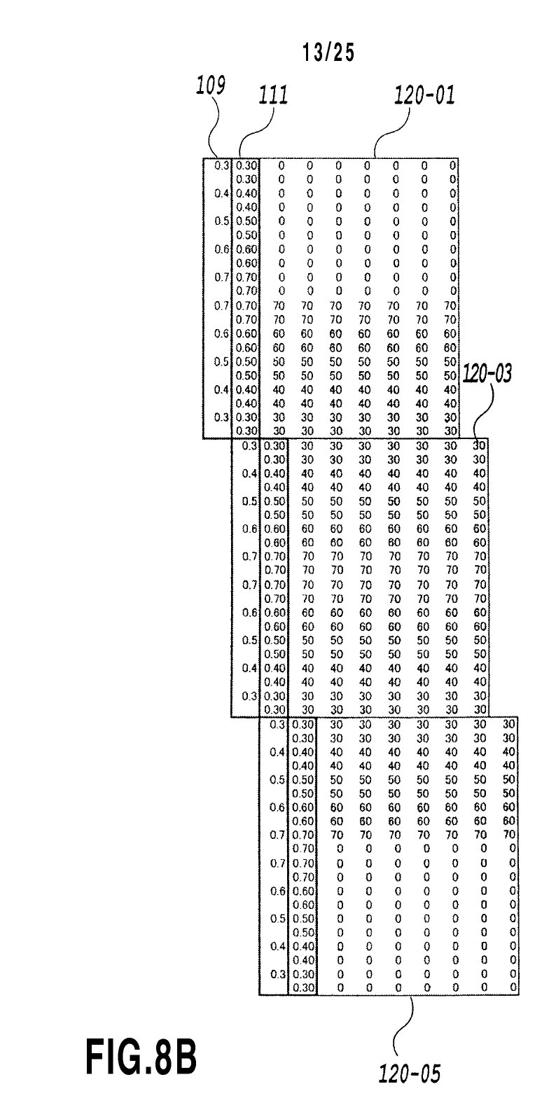

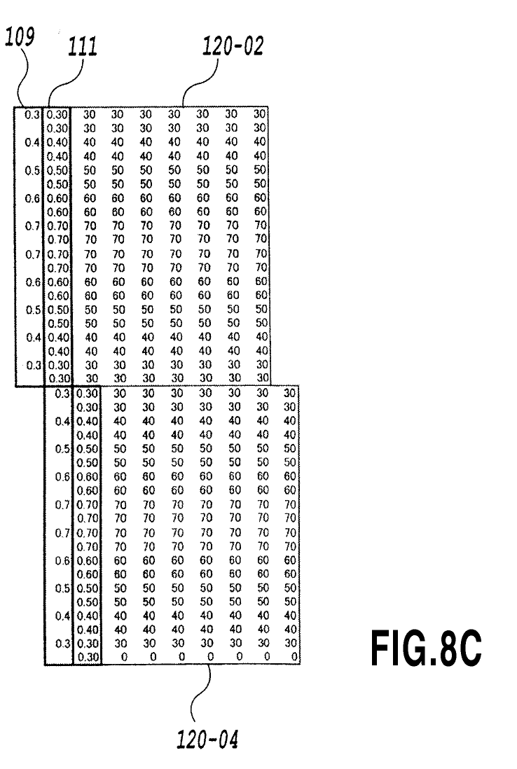

It is noted that the distribution coefficients 109 need not be matched to every other print element when stored in memory. Where the distribution coefficient is changed progressively as in this embodiment, the other distribution coefficients can be interpolated by a simple linear equation, thus minimizing the memory capacity. Also as shown in FIG. 8, the same distribution coefficients may be repetitively used for some continual print elements. Conversely, even in a configuration where the interpolation operation is executed by more complex equations, this embodiment is effectively applied. In either case, as long as the distribution coefficients corresponding to many print elements can be calculated from fewer distribution coefficients corresponding to a part of the print elements, the effect of this embodiment can be produced. It is of course possible to perform an even greater number of multipass printings by determining individual distribution coefficients such that the sum of the distribution coefficients for a plurality of print elements that print the same pixel line is 1.0.

### Embodiment 3

In this embodiment, too, the printing apparatus of embodiment 1 shown in FIG. 1 is used.

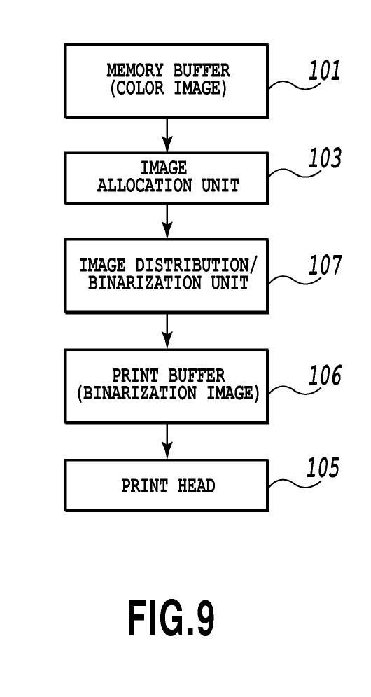

FIG. 9 is a block diagram showing a sequence of steps in an image processing operation executed by the printing apparatus of this embodiment. Other units than the image distribution/binarization unit 107 are the same as in the above embodiments.

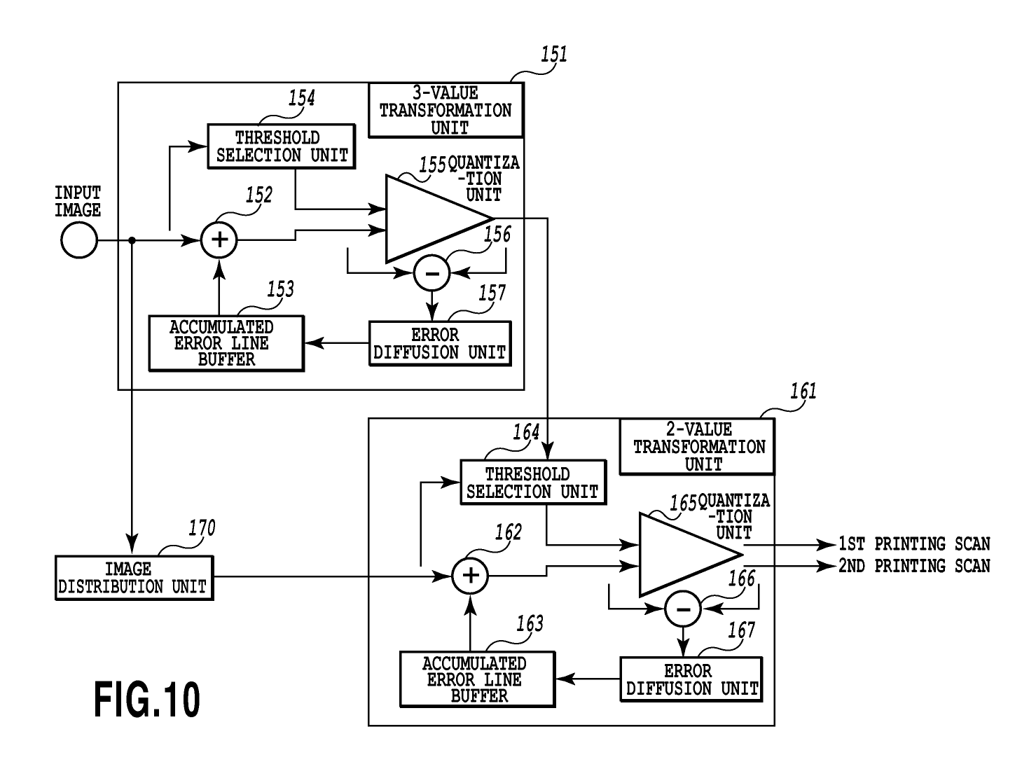

FIG. 10 is a block diagram showing a configuration of the image distribution/binarization unit 107. The image distribution/binarization unit 107 of this embodiment comprises mainly three units—an image distribution unit, a 3-value transformation unit 151 and a binarization unit 161. In the following description, a 2-pass printing will be explained.

Multivalued image data input_12 that has been color-separated by the CMYK conversion unit 102 and transferred to the image distribution/binarization unit 107 is entered into the 3-value transformation unit 151 and the image distribution unit 170. In the 3-value transformation unit 151 an error Err_12(x) stored in an accumulated error line buffer is added to the Input_12 and then I_12=Input_12+Err_12(x) is sent to the quantization unit 155.

In the accumulated error line buffer 153, memories Err_12(x) corresponding in number to pixels w, that store accumulated errors corresponding to the position x of pixel of interest in the main scan direction (that is, 1≦x≦w), are provided. In addition to this, an error memory Err_12_0 for one pixel is also provided.

The threshold selection unit 154 selects a threshold for 3-level value conversion according to a value of Input_12. The input image data Input_12 of this embodiment is represented by a 0-255 level 8-bit signal and the threshold selection unit 154 sets a threshold Th_12 to Th_12=63 (0≦Input_12<128) and Th_12=191 (128≦Input_12≦255).

The quantization unit 155 uses the threshold Th_12 selected by the threshold selection unit 154 to quantize the image data I_12, to which errors are added, into a 3-value. As a result, the quantization unit 155 outputs Out_12. That is, if the quantized output is Out_12, then Out_12=0 (0≦Input_12<128 and I_12<Th_12=63), Out_12=127 (0≦Input_12<128 and I_12≧Th_12=63) or (128≦Input_12≦255 and I_12<Th_12=191), and Out_12=255 (128≦Input_12≦255 and I_12≧Th_12=191)

In this embodiment, Out_12 is a 3-level value representing the number of dots that are to be printed in the first and second scan on a pixel of interest. More specifically, Out_12=0 means that no dot is printed in the pixel of interest. Out_12=127 means that one dot is printed in the pixel of interest by one of the first and second scan. Out_12=255 means that two dots are printed in the pixel of interest by both of the first and second scan.

The error computation unit 156 calculates an error Err_12 produced by the quantization operation, from an input value I_12 to and an output value Out_12 from the quantization unit 155. That is, Err_12=I_12−Out_12.

The error diffusion unit 157 diffuses (distributes) Err_12 to surrounding pixels according to the position x in the main scan direction of the pixel of interest.

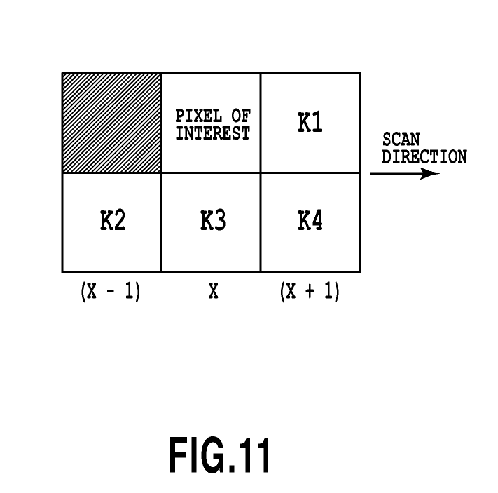

FIG. 11 is an error distribution matrix showing diffusion coefficients used by the error diffusion unit 157 when it distributes error to neighboring pixels. In this embodiment error is diffused based on four coefficients K1-K4 to surrounding pixels that adjoin the pixel of interest in the main scan and subscan directions. In this embodiment, K1= 7/16, K2= 3/16, K3= 5/16 and K4= 1/16. That is, of the error that has occurred in the pixel of interest, 7/16 is diffused to a pixel to the right of the pixel of interest, which is to be processed next, and the remaining 9/16 is diffused to those pixels on the next line down. It is noted that Err_12(1) to Err_12(w) for the management of accumulated errors do not represent accumulated errors of pixels lying in the same line as the pixel of interest. If we let a coordinate of a pixel of interest in the main scan direction be x, Err_12(x+1) to Err_12(w) represent accumulated errors of pixels in the same line as that of the pixel of interest and Err_12(1) to Err_12(x) represent accumulated errors of pixels in a line directly below the line of the pixel of interest. Each time the position of the pixel of interest advances, the positions that the error memories represent shift to the next tier down, one pixel lower. When an error produced in the pixel of interest is diffused, a pixel lying to the right of the pixel of interest and a pixel lying to the lower right are both (x+1) in the main scan direction coordinate. Therefore, to distinguish the error for the pixel lying to the lower right of the pixel of interest from the accumulated error for the pixel lying to the right Err_12(x+1), one-pixel memory Err_12_0 is used. That is, errors for the surrounding pixels are diffused and accumulated, as described below, and the results are written over the accumulated error line buffer.

E_{—}12(x+1)=E_{—}12(x+1)+Err_{—}12×K1(x<w)

E_{—}12(x−1)=E_{—}12(x−1)+Err_{—}12×K2(x>1)

E_{—}12(x)=E_{—}12_{—}0+Err_{—}12×K3(1<x<w)

E_{—}12(x)=E_{—}12_{—}0+Err_{—}12×(K2+K3)(x=1)

E_{—}12(x)=E_{—}12_{—}0+Err_{—}12×(K1+K3+K4)(x=w)

E_{—}12_{—}0=Err_{—}12×K4(x<w)

E_{—}12_{—}0=0(x=w)

Initial values for the accumulated error line buffer 153 may all be 0 or set with random numbers.

The multivalued image data Input_12 is distributed by the image distribution unit 170 to generate nearly halved, multivalued data which is to be printed in the first scan. This distribution method, as described in the above embodiments, is performed according to a predetermined distribution coefficient to extract grayscale value only for the first scan.

The distributed, multivalued data Input is entered into the binarization unit 161. To the input signal value Input is added an error Err_1(x) stored in an accumulated error line buffer 163 by an addition unit 162, which sends I=Input+Err(x) to the quantization unit 165.

Input is also sent to a threshold selection unit 164 which selects a threshold for binarization according to the value of Input. The selection operation by the threshold selection unit 164 may be similar to that performed by the above threshold selection unit 154. It is however not essential in this embodiment to prepare a plurality of thresholds in the binarization unit. Whatever the value of the input image data Input, the threshold selection unit 164 may set the threshold Th at Th=64 (0≦Input_1≦255). To avoid dot generation delays, it is possible to change the threshold Th more precisely according to the input image data Input.

The quantization unit 165 compares the threshold Th selected by the threshold selection unit 164, the image data I to which an error is added, and an output value Out_12 from the 3-value transformation unit 151 and then determines an output value for the first scan Out_1 and an output value for the second scan Out_2. That is, when Out_12=0, Out_1=0 and Out_2=0; when Out_12=255, Out_1=1 and Out_2=1; and when Out_12=127, Out_1=1 and Out_2=0 (Out_12−I<Th), and Out_1=0 and Out_2=1 (Th≦Out_12−I). With this configuration, the output value for the first scan Out_1 and the output value for the second scan Out_2 can be determined simultaneously by the quantization unit 165.

An error calculation unit 166 calculates an error Err_1, a difference between I and an output pixel value Out_1. That is,

Err_{—}1=I−Out_{—}1

An error diffusion unit 167 diffuses the error Err_1 to the surrounding pixels according to the position x in the main scan direction of a pixel of interest in the same way as the 3-value transformation unit 151. Let w stand for a maximum value of the coordinate x, i.e., the number of pixels in the main scan direction, and E_1(x) stand for an accumulated error at the coordinate x. Then, the error is diffused to the adjoining pixels as follows.

E_{—}1(x+1)=E_{—}1(x)+Err_{—}1×K1(x<w)

E_{—}1(x−1)=E_{—}1(x)+Err_{—}1×K2(1<x)

E_{—}1(x)=Err_{—}1_{—}0+Err_{—}1×K3(1<x<w)

E_{—}1(x)=Err_{—}1_{—}0+Err_{—}1×(K2+K3)(x=1)

E_{—}1(x)=Err_{—}1_{—}0+Err_{—}1×(K1+K3+K4)(x=w)

Err_{—}1_{—}0=Err_{—}1*(K4)(x<w)

Err_{—}1_{—}0=0(x=w)

To diffuse and accumulate errors as described above, the accumulated error line buffer 163 has a memory area Err_1_0 for one pixel and memory areas E_1(x) for w of the pixels arrayed in the main scan direction. Each time the pixel of interest is changed, the error is accumulated according to the above equations. The initial values for the accumulated error line buffer 163 may all be 0 or set with random numbers.

This embodiment is characterized in that one quantization unit 165 simultaneously outputs both binary data for the first scan and binary data for the second scan.

### Embodiment 4

In this embodiment also, the printing apparatus of embodiment 1 shown in FIG. 1 is used.

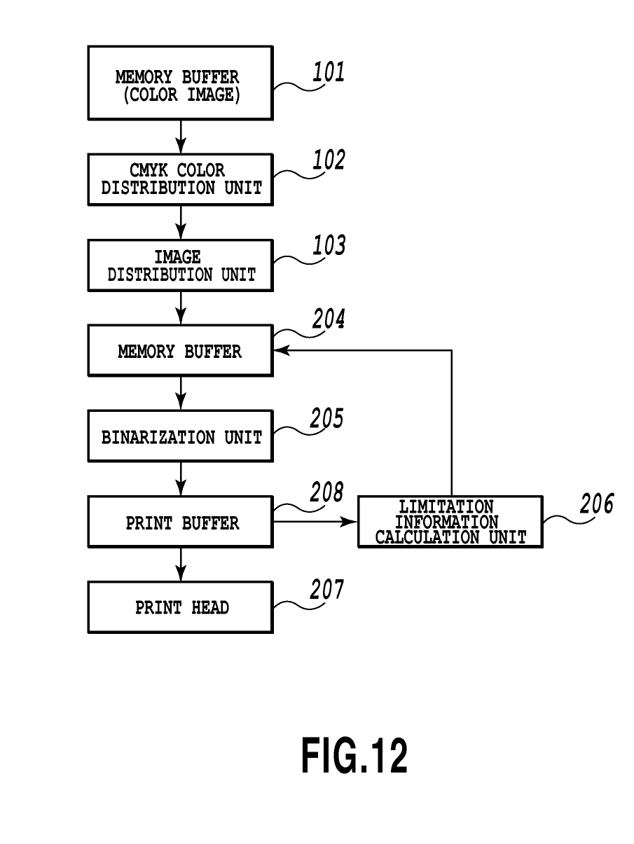

FIG. 12 is a block diagram showing a sequence of steps in an image processing operation executed by the printing apparatus of this embodiment. Operations up to the image distribution unit 103 are similar to embodiment 1 or 2. This embodiment is characterized in that the processing by the binarization unit 205 is executed based on binarized information of the previous plane so as to scatter dots printed by the same printing scan as uniformly as possible. The image processing in this embodiment will be described in detail as follows.

Grayscale value distributed for a plurality of planes by the image distribution unit 103 is stored in individual areas of the memory buffer 204. A plane corresponding to the first printing scan for the same image area on a print medium is defined to be a first plane and a plane corresponding to the second printing scan for the same image area on the print medium is defined to be a second plane.

The following processing is executed beginning with the first plane. Grayscale value for the first plane is stored as is in the memory buffer 204 and then sent to the binarization unit 205.

The binarization unit 205, as in the preceding embodiments, performs binarization operation on each of grayscale value stored in the memory buffer 204 by using an error diffusion method or a dither matrix method. Binary data thus obtained is transferred to a print buffer 208. When image data for one printing scan is accumulated, the print head 207 performs the printing scan according to the binary data stored in the memory buffer 204. The binarized result for the first plane is also transferred to the limitation information calculation unit 206.

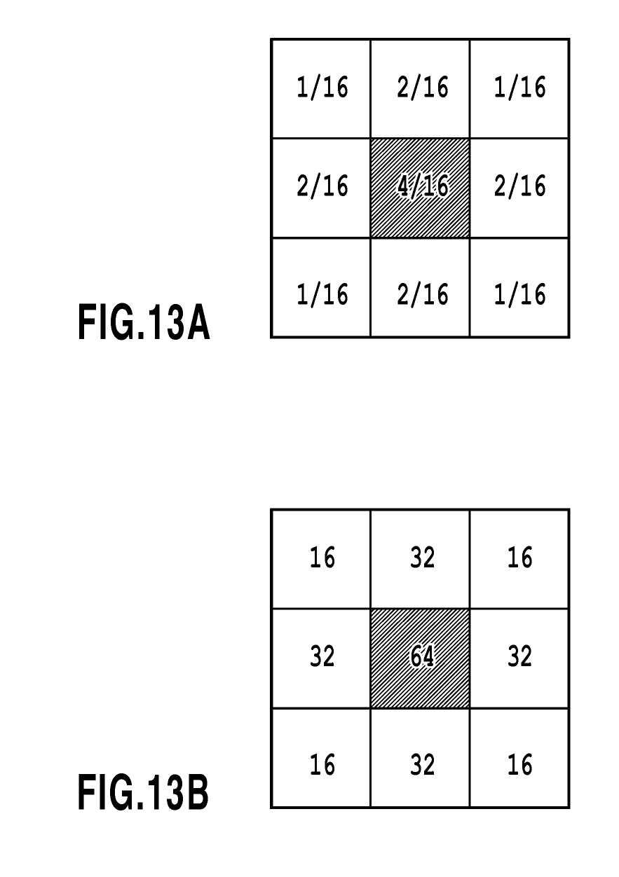

FIG. 13A shows coefficients used for a filter calculation that the limitation information calculation unit 206 performs on the binary data for the first plane output from the binarization unit 205. FIG. 13B shows results of calculation. A shaded pixel represents a pixel of interest to be processed by the binarization unit 205. The limitation information calculation unit 206 diffuses the binarized results to the neighboring pixels according to the coefficients of FIG. 13A. That is, if an output from the binarization unit 205 is print (255), the result of diffusion to the neighboring pixels is as shown in FIG. 13B.

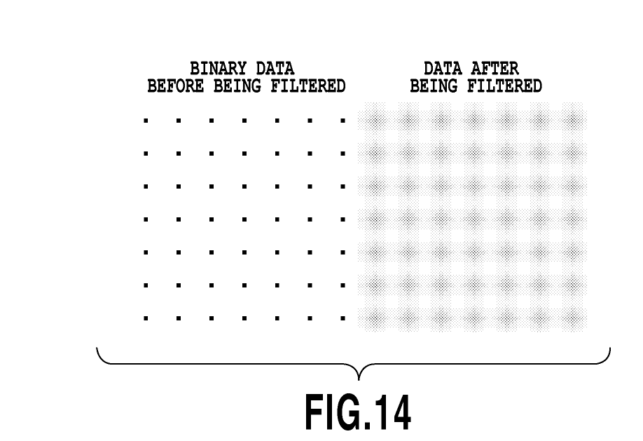

FIG. 14 shows an image of an output result (pre-filter binary data) from the binarization unit 205 and an image of the output result after being subjected to the filtering operation (post-filter data). The limitation information calculation unit 206 converts the allocated values thus obtained (values of FIG. 13B) into minus values and adds the converted values to the multivalued data for the first plane before being binarized, to obtain correction data (limitation information). This correction data is multivalued correction data used to correct image data for the second plane. The multivalued correction data (limitation information) thus obtained is stored in pixel positions for the second plane in the memory buffer 204. That is, in the example of FIG. 6, only the lower five pixel lines are stored at positions corresponding to the five pixel lines on the second plane.

In the processing for the next second plane, the multivalued image data is added to the above limitation information (multivalued correction data) stored in advance in the memory buffer 204 and saved there. Then, as in the case of the first plane, the data in the memory buffer 204 is binarized and transferred to the print buffer 208. The binarized result for the second plane is also transferred to the limitation information calculation unit 206 as with the first plane. The above binarization operation is repeated until the planes for all printing scans are completely binarized.

In the binarization of the second plane, the data values for those pixels that have been determined to be printed (1) in the first plane become lower than the original values, reducing the possibility of the pixel and its neighboring pixels to be printed (1) by the binarization operation. As a result, in an area of a print medium printed by the first plane (first printing scan) and the second plane (second printing scan), a likelihood of two dots being printed overlapping is reduced. This in turn can prevent a degradation of granularity caused by too much overlapping of dots.

As described above, to suppress density unevenness caused by inter-plane registration deviations, it is effective to make sure that dots printed by a plurality of printing scans are not in a complementary relation with each other, that is, it is effective to have pixels where dots printed by two or more different printing scans overlap. However, too many of such pixels will give rise to a possibility of causing a reduction in the density of image due to a reduced coverage or degrading granularity due to too much overlapping of dots. By allowing for the presence of those pixels where dots are overlappingly printed in a plurality of printing scans and at the same time keeping the likelihood of occurrence of such pixels low, as in this embodiment, the density variations can be suppressed to an appropriate degree without producing too many of such pixels with overlapping dots. As described above, with this embodiment, dot arrangements can be obtained that produce high density, low granularity and high resistance to density variations.

Further, since this embodiment employs an error diffusion technique, dots printed by a plurality of printing scans can be scattered properly, suppressing low-frequency components of image produced by the dot arrangements. This in turn reduces granularity of a printed image caused by dot arrangement in a plane (in the same printing scan). Generally, registration shifts between different planes (printing scans) can result in a dot arrangement pattern (texture) being visible and recognized as image impairments. However, if the dot arrangement in each plane is well resistant to granularity as in this embodiment, inter-plane registration deviations can hardly result in image impairments. That is, while adjusting the print duties of individual print elements according to their positions on the print head, this embodiment can enhance the robustness against not only density variations but textures, thus producing an image with reduced granularity.

While we have explained the 2-pass printing, this invention can produce an image with a greater number of passes. That is, this embodiment can be applied to an M-pass printing (M is an integer equal to or larger than 2). When an M-pass printing is performed, the image distribution unit 103 distributes the entered multivalued image data into a plurality of planes according to distribution coefficients for individual print elements in the same way as in the preceding embodiments. Then, the limitation information calculation unit 206 accumulates successively at predetermined pixel positions in the memory buffer 204 the image data of the first to (M−1)st plane after being subjected to the filtering operation. As a result, when data of M planes are binarized, those pixels that have been specified to be printed (1) in one of 1st to (M−1)st plane are less likely to be printed with a dot in an Mth printing scan. As described above, a probability of dots printed in different printing scans overlapping each other can be lowered.

While this embodiment uses as a filter for the limitation information calculation unit 206 an isotropic weighted mean filter having a 3×3-pixel area with coefficients arranged almost concentric as shown in FIG. 13A, this invention is not limited to this configuration. The filter may be of a larger square with a 5×5-pixel or 7×7-pixel area, or even an anisotropic filter may be used which has a rectangular shape of a 5×7-pixel or 5×9-pixel area with filter coefficients arranged oval. Further, the filter may have a low-pass, band-pass or high-pass characteristic.

### Other Embodiments

As described in the preceding embodiments, the present invention is characterized in that the distribution coefficients are determined according to the positions of print elements on the print head, not the positions of print data. Thus, the image data distribution method described above is also effectively applied to a full-line type printing apparatus having a plurality of print heads, such as shown in FIG. 19. When there is a printing element with an unstable ejection state at a particular position, a distribution coefficient of image data corresponding to the position of such a print element is set low in order to alleviate image impairments that would otherwise be caused by the problematic print element. If such an effect is to be desired, this invention is not limited to ink jet printing apparatus. This invention can be suitably applied to whatever printing apparatus prints an image on a print medium by moving a print head relative to the print medium, the print head having a plurality of print elements that form dots on the print medium. That is, as long as an image is printed on a print medium by a dot-forming print head during a relative movement between the print head and the print medium, this invention is effectively applicable in addition to the ink jet printing apparatus.

Although the above embodiments employ a binarization operation as a grayscale level number reduction operation, other grayscale level number reduction operations may be used. For example, 3-level or 4-level transformation operation may be used, which in general form is expressed as an N-level transformation operation (N is an integer equal to or higher than 2).

An image processing apparatus that executes characteristic image processing of this invention has been explained by taking as an example the printing apparatus having an image processing function shown in FIG. 5, FIG. 9 and FIG. 12. This invention however is not limited to this configuration. For example, the image processing of this invention may be executed by a host device, after which binarized image data may be entered into the printing apparatus. As another example, images shot by a digital camera or graphic images may be directly entered into a printing apparatus, with no host device in between, and the above characteristic image processing operations may all be executed by the printing apparatus. The image processing apparatus of this invention is represented by the host device in the former case and by the printing apparatus in the latter case. The characteristic image processing of this invention involves, as can be seen from the above embodiments, distributing a multilevel grayscale value according to distribution coefficients determined and matched one-to-one with the print elements and quantizing the distributed individual grayscale values.

This invention is also implemented by a program code that realizes the above image processing function or by a storage media containing the program code. In that case, the image processing is implemented by a host device or a computer (or CPU and MPU) in a printing apparatus reading and executing the program code. As described above, this invention also includes a computer-readable program to cause the computer to execute the above image processing operation and a storage media storing that program.

Among the storage media for supplying the program code are floppy disks (registered trade mark), hard disks, optical discs, magnetooptical discs, CD-ROMs, CD-Rs, magnetic tapes, non-volatile memory cards and ROMs.

Not only is the function of the above embodiments implemented by the computer executing the loaded program code, but an operating system running on the computer may also execute a part or all of the actual processing according to instructions of the program code. Another configuration is also possible, in which, after the program code is written into a memory of a function expansion board inserted into the computer or of a function expansion unit connected to the computer, a CPU may execute a part or all of the actual processing according to the instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-329335, filed Dec. 20, 2007, which is hereby incorporated by reference herein in its entirety.

What is claimed is:

1. An image forming apparatus for forming an image on a print medium by using a print head having a plurality of print elements that print dots, the image forming apparatus comprising:
distribution unit configured to distribute multilevel grayscale data of pixels according to distribution coefficients determined for the print elements to be used to print dots to the pixels;
grayscale reduction unit configured to reduce values of the grayscale data distributed by said distribution unit; and
printing controller configured to cause the print head to print the dots on the print medium according to the data whose values are reduced by said grayscale reduction unit.

2. An image forming apparatus according to claim 1, wherein the print head is scanned a plurality of times over the same image area of the print medium to form an image in the same image area;
wherein said distribution unit distributes, according to the distribution coefficients determined for the print elements, the multilevel grayscale data of the pixels in each of areas that can be printed by individual scans of the print head;
wherein said grayscale reduction unit binarizes, for each of the areas, the grayscale data distributed by said distribution unit;
wherein said printing controller cause the print head to print dots on the print medium according to the data binarized for each of the areas.

3. An image forming apparatus according to claim 1, wherein a plurality of the print heads are used to print an image on the print medium;
wherein said distribution unit distributes the multilevel grayscale values of the pixels according to distribution coefficients determined for the print elements of the plurality of print heads to be used to print dots to the pixels;
wherein said grayscale reduction unit binarizes the grayscale data distributed by said distribution unit and generates binary data to be printed by the plurality of print heads.

4. An image forming apparatus according to claim 1, wherein the distribution coefficient is set smaller as the print element approaches an end of the print head.

5. An image forming apparatus according to claim 1, wherein the distribution coefficients are determined by calculating distribution coefficients for all of the print elements from predetermined distribution coefficients corresponding to a part of the print elements.

6. An image forming apparatus according to claim 1, wherein the number of the distribution coefficients is smaller than the number of print elements.

7. An image forming apparatus according to claim 1, wherein said grayscale reduction unit performs a binarization operation by using an error diffusion method.

8. An image forming apparatus according to claim 1, wherein said grayscale reduction unit performs a binarization operation by using a dither matrix method.

9. An image forming apparatus according to claim 2, wherein said grayscale reduction unit performs a binarization operation such that dots printed by a plurality of scans over the same image area are arranged exclusive in position to each other.

10. An image forming method for forming an image on a print medium by using a print head having print elements that print dots on the print medium, the image forming method comprising:
a distribution step of distributing multilevel grayscale data of pixels according to distribution coefficients determined for the print elements to be used to print dots to the pixels;
a grayscale reduction step of reducing values of the grayscale data distributed by said division step; and
a step of printing dots on the print medium according to the data whose values are reduced by said grayscale reduction step.

11. A data processing apparatus for processing data used to form an image on a print medium by using a print head having print elements that print dots, the processing comprising:
a distribution step of distributing multilevel grayscale data of pixels according to distribution coefficients determined for the print elements to be used to print dots to the pixels; and
a step of reducing values of the grayscale data distributed by said division step.
